(19) United States
(12) Patent Application Publication
(10) Pub. No.: US 2014/0325565 A1
(43) Pub. Date: Oct. 30, 2014

(54) CONTEXTUAL COMPANION PANEL

(71) Applicant: Microsoft Corporation, Redmond, WA (US)

(72) Inventors: Preetinderpal Singh Mangat, Surrey (CA); Peter Duyen Hung Hoang, Delta (CA); Daniel Frank, North Vancouver (CA); Shannon Yen Yun Lee, Vancouver (CA); Joshua Trusz, Vancouver (CA); Sang Young Park, Burnaby (CA); Daniel Daigle, Vancouver (CA); Helen Joan Hem Lam, Richmond (CA); William Michael Mozell, North Vancouver (CA); David Seymour, Vancouver (CA); Michael James Perzel, Vancouver (CA); Jiageng Tian, Vancouver (CA)

(73) Assignee: Microsoft Corporation, Redmond, WA (US)

(21) Appl. No.: 14/199,861

(22) Filed: Mar. 6, 2014

Related U.S. Application Data
(60) Provisional application No. 61/816,691, filed on Apr. 26, 2013.

(51) Int. Cl. H04N 21/4788; H04N 21/482; H04N 21/472

(52) U.S. Cl. CPC H04N 21/4788; H04N 21/47202; H04N 21/482
USPC 725/43; 725/100

(57) ABSTRACT

A client system obtains video content data from a remote system and obtains or determines corresponding video time data. Additionally, the client system obtains contextual content data and corresponding contextual time data from a remote system. The client system identifies portions of the contextual content data that are temporally related to portions of the video content data based on the contextual time data and the video time data. Further, the client system displays a portion of the video content data on the display device. Additionally, based on results of the identifying, while displaying the portion of the video content data on the display device, the client system also displays, alongside the portion of the video content data, a portion of the contextual content data that is relevant to the portion of the video content data being displayed on the display device.

### PRIORITY CLAIM

This application claims priority to U.S. Provisional Patent Application No. 61/816,691, filed Apr. 26, 2013, which is incorporate herein by reference.

### BACKGROUND

Currently, when watching live events on television (TV), pulling up live information on the event (e.g., stats, live data/results) is something that cannot be done on the TV alongside the video content being displayed. Furthermore, there is no interactive option by which the player can specify and prioritize what data they would like to see.

Previous solutions required a user (also referred to as a watcher) to have a separate companion device to monitor relevant events outside the broadcast on a second screen, such as a table computing device or a smart phone.

### SUMMARY

A system is provided for displaying video content and a companion panel displayed alongside the video content. The companion panel can be or include a user interface (UI) element that is shown while watching the video content, that serves as an interactive information display with info/data related to the video content being played. In such a case, the companion panel may also be referred to as an activity panel. For example, when watching a live football game in ESPN, the companion or activity panel may show the live box score, scoring leaders and other game stats synced with the video stream. Furthermore, this companion or activity panel may be used for interactive actions such as participating in live polls and/or viewing fantasy team information, which are contextual (but not limited) to the live game being shown.

In accordance with an embodiment, a client system obtains video content data from a remote system and obtains or determines corresponding video time data. Additionally, the client system obtains contextual content data and corresponding contextual time data from a remote system. The client system identifies portions of the contextual content data that are temporally related to portions of the video content data based on the contextual time data and the video time data. Further, the client system displays a portion of the video content data on the display device. Additionally, based on results of the identifying, while displaying the portion of the video content data on the display device, the client system also displays, alongside the portion of the video content data, a portion of the contextual content data that is relevant to the portion of the video content data being displayed on the display device. Such contextual content data can be displayed, e.g., in a companion panel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B illustrate displayed video content and a companion panel displayed next to the video content and including contextual content data related to the video content.

FIG. 2A is a high level flow used to describe a method for presenting video content to a user via a display device.

FIG. 2B is a high level flow diagram used to provide additional details of step 204 introduced in FIG. 2A.

FIG. 2C is a high level flow diagram used to provide additional details of step 206 introduced in FIG. 2A.

FIG. 2D is a high level flow diagram used to provide additional details of step 208 introduced in FIG. 2A.

FIG. 3 includes three timelines that are used to illustrate how a client system can synchronize the displaying of video content data and corresponding contextual content data.

FIG. 4 depicts an example entertainment console and tracking system, which is an example of a client system that can be used to implement embodiments of the present technology.

FIG. 5 is a block diagram depicting the components of an example entertainment console type of client system.

FIG. 6 illustrates another example embodiment of a computing system that can be used to implement a client system described herein.

### DETAILED DESCRIPTION

A system is disclosed for displaying video content and a companion panel displayed next to or over the video content. The companion panel includes contextual content data relating to the video content. The companion panel may be interactive so that a user can select a link in the companion panel to explore the linked data in greater detail.

In embodiments, the video may be a linear TV broadcast rendered as full-screen HDMI pass-through video by a user's client computing device (also referred to as a client system) onto a user's TV. The video may include any of a variety of different types of content, such as for example a sporting event. Other types of content are contemplated.

In embodiments, the video may be identified, and thereafter a search may be performed to identify information relating to the video. This identification and search may be performed by a user's client computing device or a central service that is linked to the client's computing device by a network such as for example the Internet.

In embodiments, the video may for example be identified using electronic program guide (EPG) data and metadata relating to the scheduled TV program video that the user is viewing. Alternatively, the central service may keep track of the content being displayed which is able to identify and provide information relating to the video. The client computing device or central service may use the TV program ID from the EPG to query for data or data feeds relevant to the identified TV program video. This query may be performed in computers of the central service or over the World Wide Web in general. The program ID and/or keywords from the metadata associated with the program in the EPG or from the central service may be used as keyword searches to identify relevant data, events and/or data feeds.

It is understood that this information may come from a variety of other sources and may be accumulated in a variety of other manners in further embodiments. The information may be contextual live data information synced with video stream. For example, utilizing score data and stats data feeds delivered through the central service, the live information for the event may be synced with the video feed and delivered to the user as a unified experience.

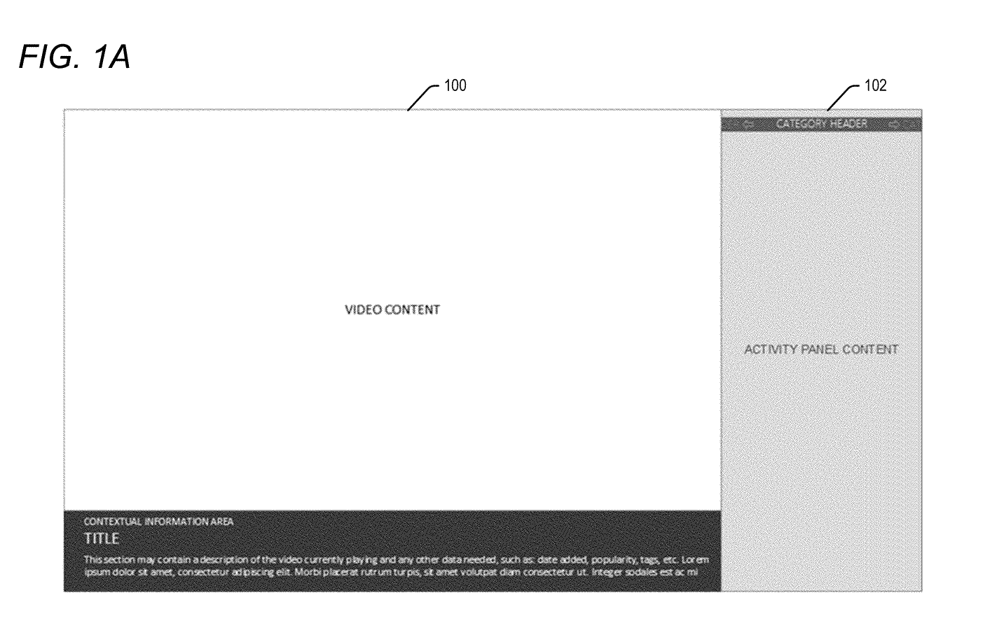

Referring to FIGS. 1A and 1B, once data, events and/or one or more data feeds (collectively referred to herein as cloud data) relevant to video content 100 are identified, this information may be displayed alongside the video content 100 in a companion panel 102. The companion panel 102 can be displayed to one side of the video content 100, e.g., to the right of the video content 100 as shown in FIGS. 1A and 1B, or alternatively to the left of the video content 100. Alternatively, the companion panel 102 can be displayed above or below the video content 100. It is also possible that the companion panel 102 can be displayed in a window whose position relative to the video content is movable or otherwise selectable by a user. Depending on implementation, such a window may or may not overlay the video content 100.

In certain embodiments, the companion panel 102 is interactive, in which case it can also be referred to as an activity panel. Upon a user selecting the companion panel 102, such as for example via a selection device, the companion panel 102 may present additional information in the companion panel on the selected topic. Such a selection device can be a game controller, a remote control, a touchpad, a track-pad, a mouse, or a microphone that accepts voice commands, but is not limited thereto.

Moreover, companion panel 102 may include interactive elements which will correspond to the video stream. These may be curated programmatically and manually by a live operations team. In a programmatic example, while watching a live game, before the game is scheduled to start, a live poll questions may be presented such as, “Who do you think will win?” with the two teams listed as options. The user can make their selection and see global pick trends. In a manual example, using the same sporting event example, half-way through the game a live operations personnel may post a situation-based question through a live publishing tool such as: “Do you agree with the referee's decision on ejecting [PlayerX] from the game?” with a list of possible answers.

The companion panel 102 may provide a variety of additional links and information, including news stories, and historical, statistical and biographical information. In one example, the central service or other cloud services may use the cloud data to query for relevant related IPTV video content which may then also be displayed as part of the expanded companion panel 102.

In an alternative embodiment, selection of a link in the companion panel 102 may bring up additional information that is displayed on a second client device, instead of the same device that is displaying the underlying video content 100. SmartGlass, for example, is a known software platform allowing information to be viewed on a second connected device.

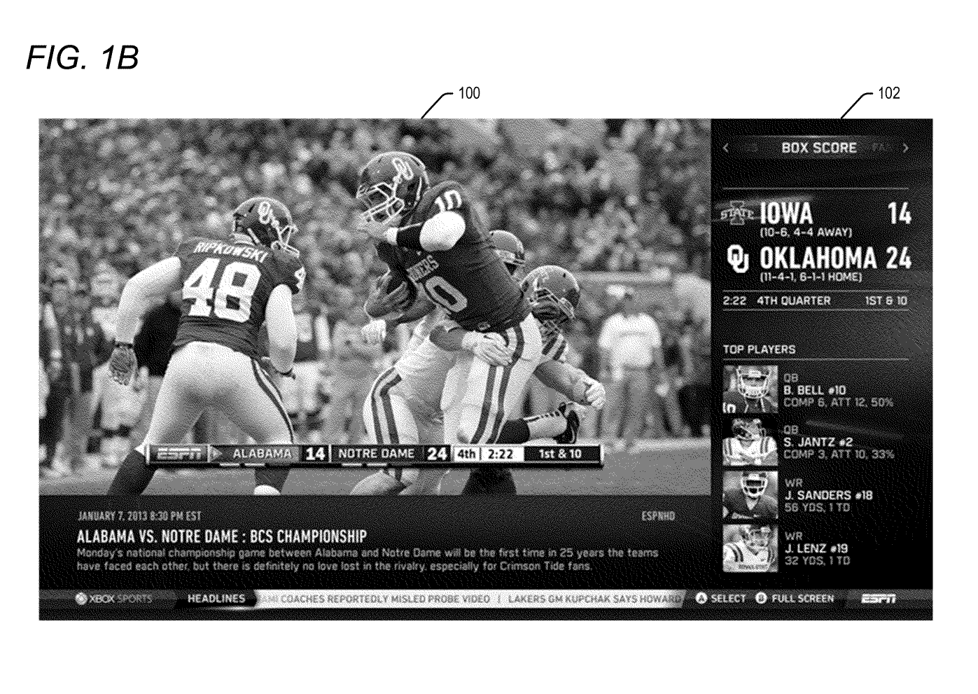

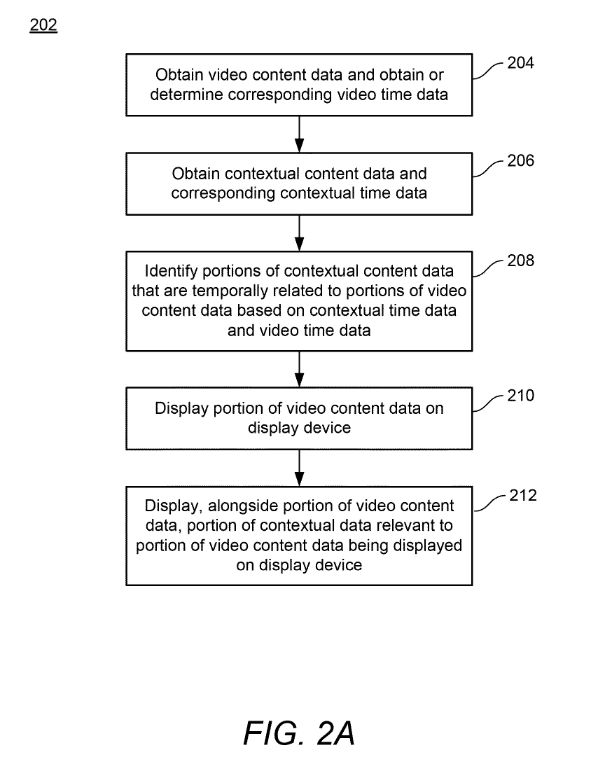

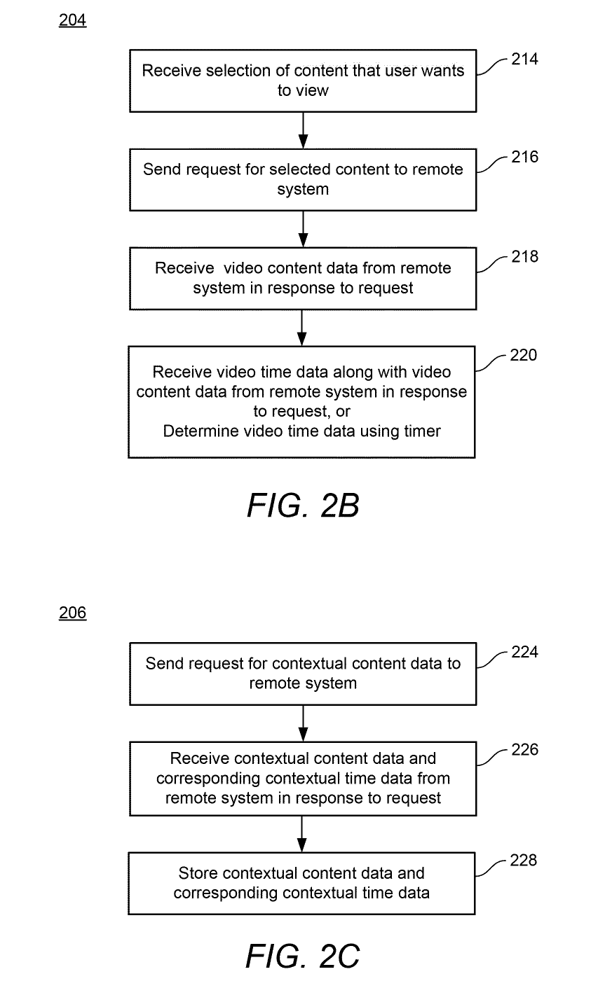

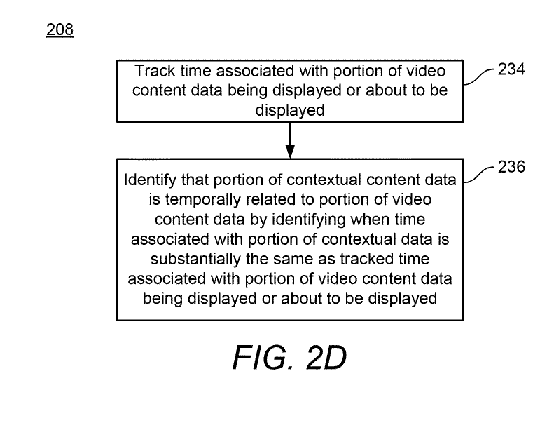

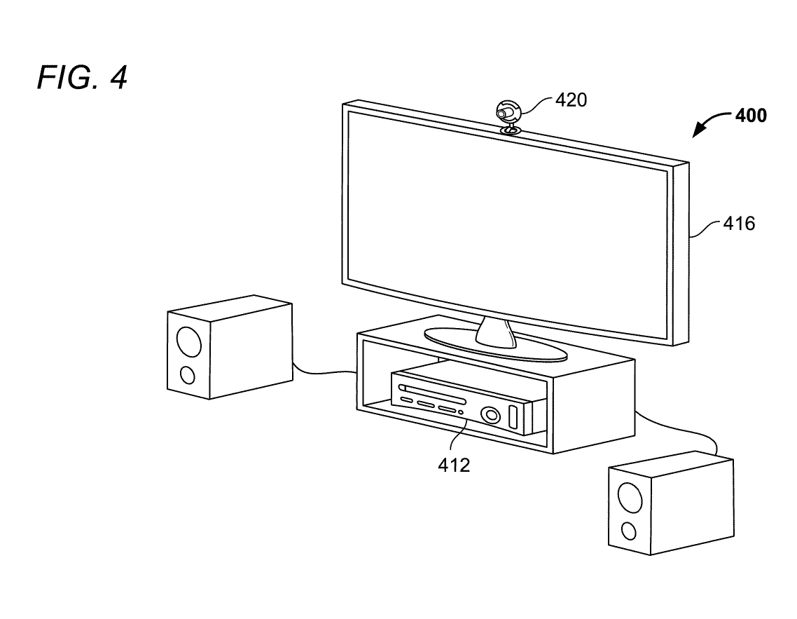

The high level flow diagram in FIG. 2A will now be used to now be used to describe a method 202 for presenting content to a user via a display device, wherein the method 202 is for use by a client system including or coupled to a display device. Such a client system can be, e.g., a gaming console, a set-top box, or the like, which is connected to (or includes) a display device, such as, but not limited to a television, a computer monitor, or other visual (or audio/visual) display device. Additional details of exemplary client systems, with which the method 202 can be used, are described below with reference to FIGS. 4-6.

Referring to FIG. 2A, at step 204 video content data is obtained. Additionally, corresponding video time data is obtained or determined at step 204. The video content data can be video data or audio-visual data that a client system can use to cause content (e.g., a football game) to be displayed on a display device. The format of the video content data can be, for example, MPEG-4, Audio Video Interleaved (AVI), Advanced Systems Format (ASF) or Windows Media (WMV), but is not limited thereto. The video time data is indicative of the timing of the video content data, and thus, indicates actual or relative timing of the portion of the video content data that is being displayed, was just displayed, or is about to be displayed. For example, the video time data can provide information about the elapsed time since the beginning of the video content data. In an embodiment, the video time data can be a time stamp that uniquely identifies each frame of video in hours, minutes and seconds, but is not limited thereto. In an embodiment, the video time data is embedded with or otherwise included with the video content data, e.g., as metadata. Additionally details of step 204, according to an embodiment, are provided below with reference to FIG. 2B.

Still referring to FIG. 2A, at step 206 contextual content data and corresponding contextual time data are obtained. Continuing with the example that the video content data (obtained at step 204) is audio-visual data for a football game, the contextual content data can provide information specific to the football game, and more specifically, information that is specific to specific points in time during the football game. Contextual content data can be, e.g., statistical information about the two teams competing against one another, statistical information about individual players on the teams, highlights and/or replays of an event that just happened or a similar event that happened in the past, but is not limited thereto. For example, contextual content data can be relevant to an event (e.g., a football play) that is being displayed, is about to be displayed or has just been displayed. For a more specific example, if a user is viewing a football game where a player just scored a touchdown, contextual content data may specify how many touchdowns that player has scored during the current game, during the current season and/or during that player's career. Additionally, or alternatively, contextual content data may indicate team touchdown leaders, league touchdown leaders and/or touchdown leaders for the specific position (e.g., running back or wide receiver) of the player that just scored the touchdown. Contextual time data is indicative of the timing of the contextual content data, and thus, indicates actual or relative timing of the contextual content data that is being displayed or is about to be displayed. More generally, contextual time data enables contextual content data to be synchronized with video content data, so that contextual content data displayed to a user is relevant (e.g., temporally relevant) to the video content data being simultaneously displayed to the user. In an embodiment, the contextual time data can be a time stamp that uniquely identifies the specific point in time (e.g., in hours, minutes and seconds, but not limited thereto) of the video content data for which the contextual content data corresponds. In an embodiment, the contextual time data is embedded with or otherwise included with the contextual content data, e.g., as metadata. Additionally details of step 206, according to an embodiment, are provided below with reference to FIG. 2C.

As will be discussed in additional detail below, a client system can received contextual content data corresponding to a specific point in time (which is received at the client system from a remote system at step 206) prior to the client system receiving the corresponding video content data (which is received at the client system from a remote system at step 204). This may happen, e.g., because the video content data corresponding to a point in time is likely larger than the contextual content data for that same point in time, and thus, may take longer to be transferred from a remote system to the client system. This may also happed if the transmission from a remote system of the video content data is delayed longer than the transmission of the contextual content data from a remote system. Accordingly, while step 206 is shown as following step 204 in FIG. 2A, step 206, or instances thereof, may actually occur prior to or at the same time as step 204. In other words, certain steps shown in FIG. 2A are not limited to the specific order shown therein. For a more specific example, a client system can receive contextual content data for a particular point in time, such as the time during which a touchdown is scored in a football game, prior to receiving video content data that shows the touchdown being scored. This may occur due to the transmission of the video content data being delayed a longer period of time than contextual content data. Because of this, the client system will have the contextual content data available to it and ready to be displayed as soon as the video content data being displayed catches up to the contextual content data.

Still referring to FIG. 2A, at step 208 there is an identifying of portions of the contextual content data that are temporally related to portions of the video content data, based on the contextual time data and the video time data. In other words, step 208 is performed to temporally align, i.e., synchronize, portions of the contextual content data with portions of the video content data. Additionally details of step 208, according to an embodiment, are provided below with reference to FIG. 2D.

Still referring to FIG. 2A, at step 210 a portion of the video content data is displayed on the display device. Additionally, as indicated at step 212, while the portion of the video content data is being displayed on the display device, a portion of the contextual content data (that is relevant to the portion of the video content data being displayed on the display device) is also displaying, alongside the portion of the video content data. Referring back to FIG. 1B, the video content 100 is an example of a portion of video content data being displayed, and the content within the companion panel 102 is an example of a portion of the contextual content data being displayed alongside the video content data. In other words, the contextual content data can be displayed within a companion panel. Displaying content data, as the phrase is used herein, refers to displaying content represented by data, not the actual data itself, where the actual data itself is typically represented as binary ones and zeroes.

Multiple instances of each of the steps shown in FIG. 2A can be performed in order to display content (e.g., a football game) to a user. For example, each time an instance of step 204 is performed, video content data corresponding to only a portion (e.g., twenty seconds worth) of the content (e.g., the football game) may be obtained. Similarly, each time an instance of step 206 is performed, contextual content data corresponding to only a portion (e.g., twenty seconds worth) of contextual content data may be obtained. Accordingly, steps 204-212 can be repeated periodically (e.g., every 20 seconds), or more generally, over time.

In accordance with certain embodiments, the contextual content data, that is displayed alongside the portion of the video content data being displayed, includes one or more interactive elements relevant to the portion of the video content data being displayed on the display device. For example, the interactive element may be or include a polling question. Continuing with the example where a football game is being displayed, an exemplary polling question asked just prior to the football game beginning, and/or at one or more times during the game (e.g., at halftime), is “Who do you think will win?” with the two teams listed as options. The user can make their selection and see global pick trends. In a manual example, using the same sporting event example, half-way through the game a live operations personnel may post a situation-based question through a live publishing tool such as: “Do you agree with the referee's decision on ejecting [PlayerX] from the game?” with a list of possible answers.

Other interactive elements of contextual content data may include buttons that enable the user to view additional contextual data relevant to an event that is being or was just displayed to the user. For example, assuming the scoring of a touchdown was just displayed, interactive elements of contextual content data may include options for viewing a replay, viewing additional information about the player that scored the touchdown (e.g., information about how many touchdowns that player has scored during the current game, during the current season and/or during that player's career), and/or viewing a list of team touchdown leaders, league touchdown leaders and/or touchdown leaders for the specific position (e.g., running back or wide receiver) of the player that just scored the touchdown. A further type of interactive element of the contextual content data is an option for enabling the user to obtain additional contextual content data not currently being displayed. For example, a button can be presented to the user that says “see more options,” or the like. In response to such a button being selected by the user, options for addition relevant contextual content data can be presented to the user, from which the user can make a selection. The additional contextual data may have already been received and stored by the client system, or the client system may send requests for the additional contextual data to a remote system.

Assuming a user participated in a fantasy football league, another interactive element of the contextual content data can be an option for the user to obtain information related to a fantasy football league in which the user participates. For example, in response to such an option being selected, highlights of players on the user's fantasy team may be displayed, and/or a listing of points earned by the players on the user's team can be displayed. These are just a few examples, which are not meant to be all encompassing.

Additional details of step 204 will now be described with referenced to FIG. 2B. Referring to FIG. 2B, at step 214 a selection of content that a user wants to view is received from the user. Such a selection can be performed by the user using a handheld device (e.g., such as a remote control or game controller), using gestures and/or using auditory commands, but is not limited thereto. For a more specific example, a channel or program guide may be presented to a user, which enables the user to select one of the programs from the guide for viewing. At step 216, a request for the user selected content is sent to a remote system. Such a remote system can be, e.g., a content delivery network (CDN), which is a large distributed system of servers deployed in one or more data centers across the Internet, wherein the CDN can provide live streaming media and/or on-demand streaming media. The remote system can alternatively be some other type of central feed service or cloud service. At step 218, video content data is received from the remote system in response to the request.

Still referring to FIG. 2B, at step 220, the video time data is received along with the video content data from the remote system in response to the request. As mentioned above, the video time data is indicative of the timing of the video content data, and thus, indicates actual or relative timing of the video content data that is being displayed or is about to be displayed. As also mentioned above, the video time data can be a time stamp that uniquely identifies each frame of video in hours, minutes and seconds, but is not limited thereto. In an embodiment, the video time data is embedded with or otherwise included with the video content data, e.g., as metadata, and thus, is simultaneously received along with the video content data. Alternatively, at step 220, video time data can be determined by the client system, e.g., using a timer of the client system. For example, the client system may use a timer to keep track of how longs it's been since the beginning of video content being displayed. Such a timer can be paused whenever the video content is paused, and can be turned on whenever video content is being displayed. Further, if video content being displayed is fast forwarded or rewound, the timer can similarly be fast forwarded or rewound.

Additional details of step 206 will now be described with referenced to FIG. 2C. Referring to FIG. 2C, at step 224 a request for the contextual content data is sent from the client system to a remote system. The remote system can be, e.g., a CDN, central feed service or cloud service, but is not limited thereto. In accordance with an embodiment, the remote system to which the request for contextual content data is sent (at step 224) is the same as the remote system to which the request for content is sent (at step 216). In such an embodiment, a common request can be sent for both content and contextual content data, in which case instances of steps 216 and 224 can occur simultaneously. In accordance with an alternative embodiment, the remote system to which the request for contextual content data is sent (at step 224) is different than the remote system to which the request for content is sent (at step 216). It is also possible that requests for video content data are sent to the same remote system as the requests for contextual content data, but that the remote system (that receives both types of requests), passes one of the types of requests to another remote system, or each of these types of requests to respective different remote systems that provide the response(s) to such requests. Still referring to FIG. 2C, at step 226, contextual content data and the corresponding contextual time data are received from a remote system in response to the request that was sent at step 224. As indicated at step 228, the received contextual content data and the received corresponding contextual time data can be stored at least until the contextual content data is displayed. For example, such data can be stored in buffer memory or in other types of memory. Such buffering, or more generally storing of obtained contextual content data is especially useful where contextual content data corresponding to a particular point in time is obtained prior to obtaining the video content data corresponding to the particular point.

In order to collect contextual content data, a remote system can, e.g., use a TV program ID from an EPG to query for data or data feeds relevant to particular video content data. Such queries may be performed, e.g., by one or computers of the remote system. The program ID and/or keywords from the metadata associated with the program in the EPG may be used as keyword searches to identify relevant contextual data. The contextual content data may come from a variety of different sources and may be accumulated in a variety of different manners. Since the present technology is not primarily focused on how a remote system obtains contextual data, additional details of how a remote system may obtain contextual data is not provide herein.

Additional details of step 208 will now be described with referenced to FIG. 2D. Referring to FIG. 2D, at step 234 a time associated with a portion of the video content data being displayed or about to be displayed is tracked. This can be accomplished, e.g., by reading time stamp data or other video time data associated with the video content data that is used to display content on a display device. Still referring to FIG. 2D, step 236 involves identifying that a portion of the contextual content data is temporally related to a portion of the video content data by identifying when a time associated with a portion of the contextual content data is substantially the same as the tracked time associated with the portion of the video content data being displayed or about to be displayed.

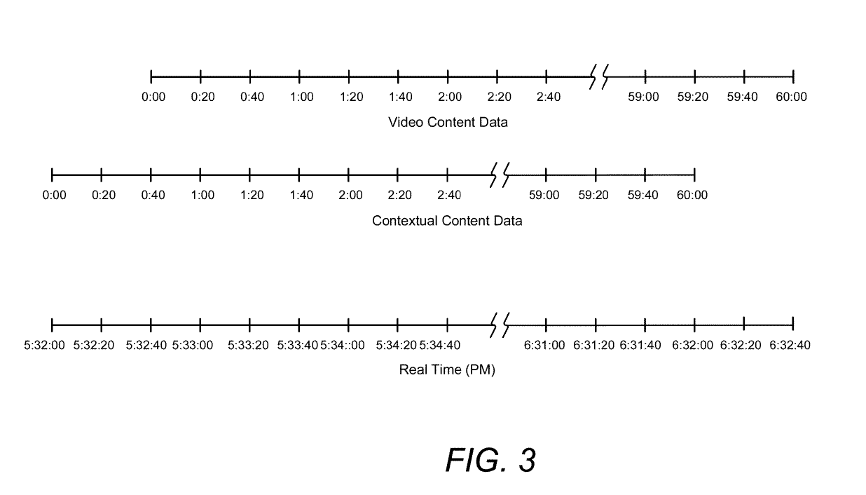

As mentioned above, contextual content data corresponding to a specific point in time (which is received at the client system from a remote system, e.g., at step 206) may be received prior to corresponding video content data (which is received at the client system from a remote system, e.g., at step 204). This may happen, as mentioned above, because the video content data corresponding to a point in time is likely larger than the contextual content data for that same point in time, and/or transmission of video content data may be delayed longer than the transmission of the contextual content data from a remote system. Accordingly, the client system may temporarily store contextual content data to have the contextual content data available to it and ready to be displayed as soon as the video content data being displayed catches up to the contextual content data. FIG. 3 illustrates an exemplary situation where contextual content data for specific points in time are received by the client system forty seconds (i.e., 0:40) prior to the client system receiving the corresponding video content data. Referring to FIG. 3, the lowermost timeline illustrates real time relative to the client system, which in this example is a period of time between 5:32:00 PM and 6:32:40 PM. In FIG. 3, where a group of three numbers are separated by colons, the first number represents hours, the second number represents minutes, and the third number represents seconds. The uppermost timeline illustrates when the client system receives video content data relative to the real time, with the numbers representing video time data. The middle timeline illustrates when the client system receives contextual content data relative to the real time, with the numbers representing content time data.

Still referring to FIG. 3, at 5:32:00 PM the client system receives and stores contextual content data corresponding to the beginning of the content to be displayed, which again will be assumed to be a football game. Forty seconds later, at 5:32:40 PM, the client system receives video content data corresponding to the beginning of the football game. At that point in time (or a period of time thereafter), the client system can begin to display the video content data and the corresponding contextual content data, since the client systems has both types of data for that particular point in time available to it. As mentioned above, displaying content data, as the phrase is used herein, refers to displaying content represented by data, not the actual data itself, where the data itself is typically represented as binary ones and zeroes. The client system can store contextual content data, and also video content data, until such data is used to display content to the user, and may continue to store such data for a period of time thereafter, e.g., in case the user chooses to rewind and review portions of the content. By receiving contextual time data prior to video content data, and using contextual time data and video time data to align the two types of data, the client system ensures that the video content data and contextual time data are synchronized with one another.

In accordance with an embodiment, whether a user watches content (e.g., a football game) substantially live, or a few days later, the content displayed to the user is the same. In other words, if a user chooses to view a football game that took place two days earlier, the viewing experience provided to the user will be the same as if the user viewed the football game during the same time the game was actually being played. A benefit of this is that contextual content data will not accidentally include “spoilers”, such as identifying the team what already won the game.

FIG. 4 provides an example embodiment of an entertainment system 400 that can be used to display the user interfaces and content described above. Entertainment system 400 may include a computing system 412, which is an example of a client system. The computing system 412 may be a computer, a gaming system or console, or the like. According to an example embodiment, computing system 412 may include hardware components and/or software components such that computing system 412 may be used to execute applications such as gaming applications, non-gaming applications, or the like. In one embodiment, computing system 412 may include a processor such as a standardized processor, a specialized processor, a microprocessor, or the like that may execute instructions stored on a processor readable storage device for performing the processes described herein. Entertainment system 400 may also include an optional capture device 420, which may be, for example, a camera that can visually monitor one or more users such that gestures and/or movements performed by the one or more users may be captured, analyzed, and tracked to perform one or more controls or actions within an application and/or animate an avatar or on-screen character.

According to one embodiment, computing system 412 may be connected to an audio/visual device 416 such as a television, a monitor, a high-definition television (HDTV), or the like that may provide television, movie, video, game or application visuals and/or audio to a user. For example, the computing system 412 may include a video adapter such as a graphics card and/or an audio adapter such as a sound card that may provide audiovisual signals associated with the game application, non-game application, or the like. The audio/visual device 416 may receive the audio/visual signals from the computing system 412 and may then output the television, movie, video, game or application visuals and/or audio to the user. According to one embodiment, audio/visual device 416 may be connected to the computing system 412 via, for example, an S-Video cable, a coaxial cable, an HDMI cable, a DVI cable, a VGA cable, component video cable, or the like. Audio/visual device 416 may be used to display the video content 100 and contextual companion panel 102 described above.

Entertainment system 400 may be used to recognize, analyze, and/or track one or more humans. For example, a user may be tracked using the capture device 420 such that the gestures and/or movements of user may be captured to animate an avatar or on-screen character and/or may be interpreted as controls that may be used to affect the application being executed by computing system 412. Thus, according to one embodiment, a user may move his or her body (e.g., using gestures) to control the interaction with a program being displayed on audio/visual device 416.

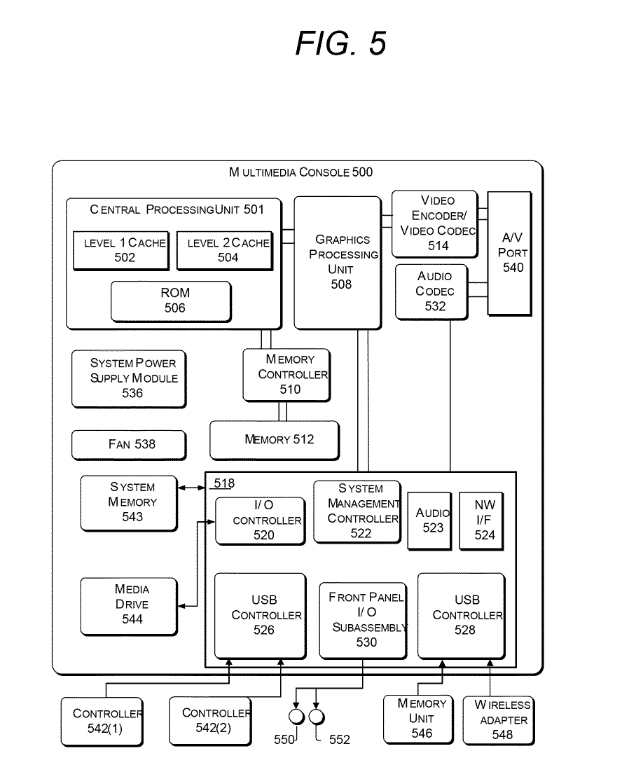

FIG. 5 illustrates an example embodiment of a computing system that may be used to implement computing system 412. As shown in FIG. 5, the multimedia console 500 has a central processing unit (CPU) 501 having a level 1 cache 502, a level 2 cache 504, and a flash ROM (Read Only Memory) 506 that is non-volatile storage. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM (Random Access Memory).

The multimedia console 500 includes an I/O controller 520, a system management controller 522, an audio processing unit 523, a network (or communication) interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548 (another example of a communication interface), and an external memory device 546 (e.g., flash memory, external CD/DVD ROM drive, removable media, etc. any of which may be non-volatile storage). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like. For a more specific example, the network interface 524 may enable a client system, e.g., 500, to communicate with a remote system that can provide the client system with video content data and/or contextual content data in accordance with embodiments described herein.

System memory 543 is provided to store application data that is loaded during the boot process. A media drive 544 is provided and may comprise a DVD/CD drive, Blu-Ray drive, hard disk drive, or other removable media drive, etc. (any of which may be non-volatile storage). The media drive 144 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 500. A system power supply module 536 provides power to the components of the multimedia console 500. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 420 may define additional input devices for the console 500 via USB controller 526 or other interface. In other embodiments, computing system 412 can be implemented using other hardware architectures. No one hardware architecture is required.

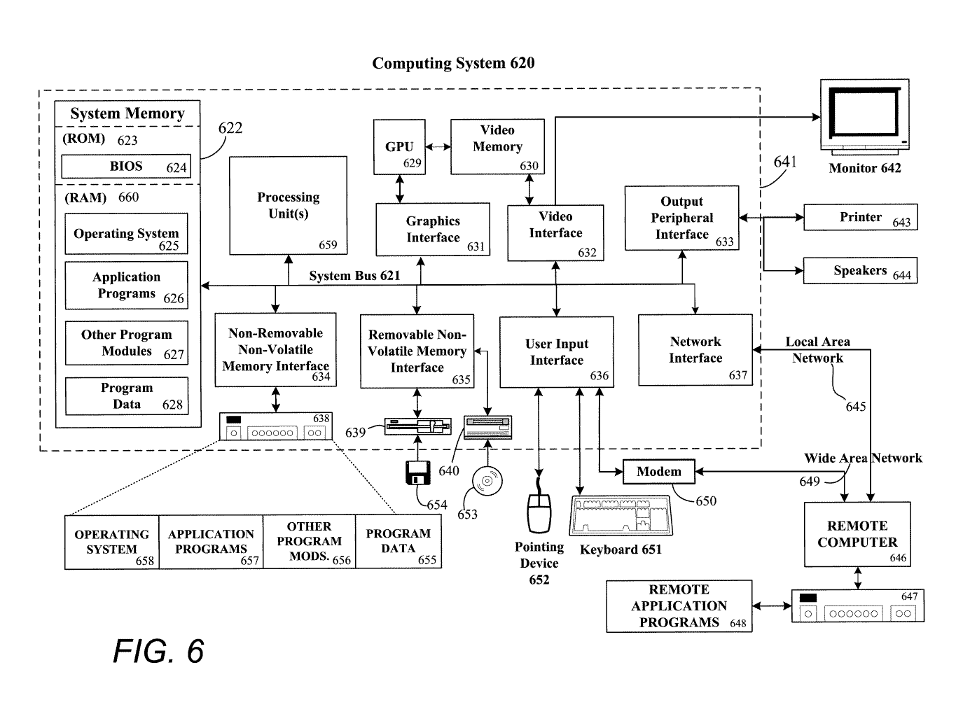

FIG. 6 illustrates another example of a computing system that can be used to implement embodiments described herein. Referring to FIG. 6, the computing system 620 is only one example of a suitable computing system and is not intended to suggest any limitation as to the scope of use or functionality of the presently disclosed subject matter. Neither should the computing system 620 be interpreted as having any dependency or requirement relating to any one or combination of components illustrated in the exemplary computing system 620. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computing system 620 comprises a computer 641, which typically includes a variety of computer readable media. The computer 641 is an example of a client system. Computer readable media can be any available media that can be accessed by computer 641 and includes both volatile and nonvolatile media, removable and non-removable media. The system memory 622 includes computer storage media in the form of volatile and/or nonvolatile memory such as read only memory (ROM) 623 and random access memory (RAM) 660. A basic input/output system 624 (BIOS), containing the basic routines that help to transfer information between elements within computer 641, such as during start-up, is typically stored in ROM 623. RAM 660 typically contains data and/or program modules that are immediately accessible to and/or presently being operated on by processing unit 659. By way of example, and not limitation, FIG. 6 illustrates operating system 625, application programs 626, other program modules 627, and program data 628.

The computer 641 may also include other removable/non-removable, volatile/nonvolatile computer storage media. By way of example only, FIG. 6 illustrates a hard disk drive 638 that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 638 is typically connected to the system bus 621 through an non-removable memory interface such as interface 634, and magnetic disk drive 639 and optical disk drive 640 are typically connected to the system bus 621 by a removable memory interface, such as interface 635.

The drives and their associated computer storage media discussed above and illustrated in FIG. 6, provide storage of computer readable instructions, data structures, program modules and other data for the computer 641. In FIG. 6, for example, hard disk drive 638 is illustrated as storing operating system 658, application programs 657, other program modules 656, and program data 655. Note that these components can either be the same as or different from operating system 625, application programs 626, other program modules 627, and program data 628. Operating system 658, application programs 657, other program modules 656, and program data 655 are given different numbers here to illustrate that, at a minimum, they are different copies. A user may enter commands and information into the computer 641 through input devices such as a keyboard 651 and pointing device 652, commonly referred to as a mouse, trackball or touch pad. Other input devices (not shown) may include a microphone, joystick, game pad, satellite dish, scanner, or the like. These and other input devices are often connected to the processing unit 659 through a user input interface 636 that is coupled to the system bus, but may be connected by other interface and bus structures, such as a parallel port, game port or a universal serial bus (USB). The capture device 420 may define additional input devices for the computing system 620 that connect via user input interface 636. A monitor 642 or other type of display device is also connected to the system bus 621 via an interface, such as a video interface 632. In addition to the monitor, computers may also include other peripheral output devices such as speakers 644 and printer 643, which may be connected through a output peripheral interface 633. Capture Device 120 may connect to computing system 620 via output peripheral interface 633, network interface 637, or other interface.

The computer 641 may operate in a networked environment using logical connections to one or more remote computers, such as a remote computer 646, which is an example of a remote system from which a client system can receive video content data and/or contextual content data. The remote computer 646 may be a personal computer, a server, a router, a network PC, a peer device or other common network node, and typically includes many or all of the elements described above relative to the computer 641, although only a memory storage device 647 has been illustrated in FIG. 6. The logical connections depicted include a local area network (LAN) 645 and a wide area network (WAN) 649, but may also include other networks. Such networking environments are commonplace in offices, enterprise-wide computer networks, intranets and the Internet. The remote computer 646 can also be part of, or represent, a CDN or some other central service feed that can provide video content data and/or contextual content data to a client system, such as the computing system 620. While only a single remote computer 646 is shown, there can be multiple such remote computers 626.

When used in a LAN networking environment, the computer 641 is connected to the LAN 645 through a network interface 637. When used in a WAN networking environment, the computer 641 typically includes a modem 650 or other means for establishing communications over the WAN 649, such as the Internet. The modem 650, which may be internal or external, may be connected to the system bus 621 via the user input interface 636, or other appropriate mechanism. In a networked environment, program modules depicted relative to the computer 641, or portions thereof, may be stored in the remote memory storage device. By way of example, and not limitation, FIG. 6 illustrates application programs 648 as residing on memory device 647. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

What is claimed is:

1. A method for use by a client system including or coupled to a display device, the method for presenting content to a user via the display device, the method comprising:
(a) obtaining video content data and obtaining or determining corresponding video time data;
(b) obtaining contextual content data and corresponding contextual time data;
(c) identifying portions of the contextual content data that are temporally related to portions of the video content data based on the contextual time data and the video time data;
(d) displaying a portion of the video content data on the display device; and
(e) based on results of the identifying, while displaying the portion of the video content data on the display device, also displaying, alongside the portion of the video content data, a portion of the contextual content data that is relevant to the portion of the video content data being displayed on the display device.

2. The method of claim 1, wherein the (a) obtaining video content data and obtaining or determining corresponding video time data comprises:
(a.1) receive a selection of content that the user wants to view;
(a.2) sending a request for the selected content to a remote system; and
(a.3) receiving the video content data from the remote system in response to the request.

3. The method of claim 2, wherein the (a) obtaining video content data and obtaining or determining corresponding video time data further comprises:
(a.4.i) receiving the video time data along with the video content data from the remote system in response to the request; or
(a.4.ii) determining the video time data using a timer of the client system.

4. The method of claim 1, wherein the (b) obtaining contextual content data and corresponding contextual time data includes:
(b.1) sending a request for the contextual content data to a remote system;
(b.2) receiving the contextual content data and the corresponding contextual time data from the remote system in response to the request; and
(b.3) storing the contextual content data and the corresponding contextual time data at least until the contextual content data is displayed.

5. The method of claim 4, wherein the (b) obtaining contextual content data corresponding to a particular point in time occurs prior to the (a) obtaining video content data corresponding to the particular point in time.

6. The method of claim 5, wherein the (c) identifying portions of the contextual content data that are temporally related to portions of the video content data comprises:
(c.1) tracking a time associated with a portion of the video content data being displayed or about to be displayed; and
(c.2) identifying that a portion of the contextual content data is temporally related to a portion of the video content data by identifying when a time associated with a portion of the contextual content data is substantially the same as the tracked time associated with the portion of the video content data being displayed or about to be displayed.

7. The method of claim 4, wherein the (b.1) sending a request for the contextual content data to a remote system comprises periodically sending requests for contextual content data to the remote system.

8. The method of claim 1, wherein the contextual content data, that is displayed alongside the portion of the video content data being displayed, includes at least one interactive element relevant to the portion of the video content data being displayed on the display device.

9. The method of claim 8, wherein a said interactive element of the contextual content data comprises a polling question.

10. The method of claim 8, wherein a said interactive element of the contextual content data comprises an option to display additional contextual content data not currently being displayed.

11. A system for presenting content to a user, comprising:
a network interface that receives video content data and corresponding video time data, and receives contextual content data and corresponding contextual time data;
a display interface that interfaces with a display device capable of displaying video content; and
one or more storage devices that store the received video content data and corresponding video time data, and store the received contextual content data and corresponding contextual time data;
one or more processors in communication with the one or more storage devices, the network interface, and the display interface, wherein the one or more processors
identify portions of the contextual content data that are temporally related to portions of the video content data based on the contextual time data and the video time data;
cause a portion of the video content data to be displayed on the display device; and
while the portion of the video content data is being displayed on the display device, also cause a portion of the contextual content data that is relevant to the portion of the video content data being displayed on the display device display, to be displayed alongside the portion of the video content data being displayed.

12. The system of claim 11, further comprising:
a user interface that enables a user to select content that the user wants to view;
wherein the network interface sends a request for the selected content to a first remote system, and receives the video content data along with the video time data from the first remote system in response to the request;
wherein the network interface sends a request for the contextual content data to a second remote system, and receives the contextual content data and the corresponding contextual time data from the second remote system in response to the request;
wherein the contextual content data corresponding to a particular point in time is received prior to the video content data corresponding to the particular point in time; and
wherein the first and second remote systems can be a same remote system or different remote systems.

13. The system of claim 12, wherein, in order to identify portions of the contextual content data that are temporally related to portions of the video content data based on the contextual time data and the video time data, the one or more processors:
track a time associated with a portion of the video content data being displayed or about to be displayed; and
identify that a portion of the contextual content data is temporally related to a portion of the video content data by identifying when a time associated with a portion of the contextual content data is substantially the same as the tracked time associated with the portion of the video content data being displayed or about to be displayed.

14. The system of claim 11, wherein the contextual content data, that is displayed alongside the portion of the video content data being displayed, includes at least one interactive element relevant to the portion of the video content data being displayed on the display device.

15. The system of claim 14, wherein a said interactive element of the contextual content data comprises a polling question.

16. The system of claim 14, wherein a said interactive element of the contextual content data comprises an option to display additional contextual content data not currently being displayed.

17. One or more processor readable storage devices having instructions encoded thereon which when executed cause one or more processors of a client system to perform a method for presenting content to a user via a display device, the method comprising:
obtaining video content data and obtaining or determining corresponding video time data;
obtaining contextual content data and corresponding contextual time data;
identifying portions of the contextual content data that are temporally related to portions of the video content data based on the contextual time data and the video time data;
displaying a portion of the video content data on the display device; and
based on results of the identifying, while displaying the portion of the video content data on the display device, also displaying, alongside the portion of the video content data, a portion of the contextual content data that is relevant to the portion of the video content data being displayed on the display device.

18. The one or more processor readable storage devices of claim 17, wherein the obtaining contextual content data and corresponding contextual time data includes:
sending a request for the contextual content data to a remote system;
receiving the contextual content data and the corresponding contextual time data from the remote system in response to the request; and
storing the contextual content data and the corresponding contextual time data at least until they are displayed;
wherein the obtaining contextual content data corresponding to a particular point in time occurs prior to the obtaining video content data corresponding to the particular point in time.

19. The one or more processor readable storage devices of claim 18, wherein the identifying portions of the contextual content data that are temporally related to portions of the video content data comprises:
tracking a time associated with a portion of the video content data being displayed or about to be displayed; and
identifying that a portion of the contextual content data is temporally related to a portion of the video content data by identifying when a time associated with a portion of the contextual content data is substantially the same as the tracked time associated with the portion of the video content data being displayed or about to be displayed.

20. The one or more processor readable storage devices of claim 17, wherein the contextual content data, that is displayed alongside the portion of the video content data being displayed, includes at least one interactive element relevant to the portion of the video content data being displayed on the display device.
